(19) United States
(12) Patent Application Publication
(10) Pub. No.: US 2005/0063706 A1
(43) Pub. Date: Mar. 24, 2005

(54) Deep space communications network

(75) Inventors: William Charles Lynch, Los Altos, CA (US); John Howard Drake, Santa Clara, CA (US); Larry Howard Capots, Mountain View, CA (US)

Correspondence Address: MCDERMOTT WILL & EMERY LLP, 18191 VON KARMAN AVE., IRVINE, CA, 92612-7107, US

(73) Assignee: Lockheed Martin Corporation

(21) Appl. No.: 10/664,881

(22) Filed: Sep. 22, 2003

(51) Int. Cl. H04B 10/00

(52) U.S. Cl. 398/118

(57) ABSTRACT

A system and method of deep space communication between a deep space location and Earth which includes communicating between a planetoid and the deep space location via an optical communications link and communicating between a user and the planetoid.

### FIELD OF THE INVENTION

The present invention relates generally to communications, and more particularly, to communications from a deep space mission to a user on or near the Earth using one or more planetoid satellites.

### BACKGROUND OF THE INVENTION

Several problems exist with prior art systems for communicating between deep space and Earth users. Typically, prior art systems use a radio frequency (RF) medium communication system to send and receive communications between deep space and Earth. These RF systems require extremely large antennas to accommodate both range and bandwidth demands of current communications needs. Conversely, large antennas cannot be easily or cost effectively used in space because of power demands and size and weight demands on the satellites that house the antennas. Furthermore, the antenna's size and weight is increased causing added expense to the launch and maintenance of the communications satellite in orbit. Consequently, the prior art deep space communications cannot be achieved to support the need for extended ranges and bandwidth.

Another problem with prior art deep space communications systems is a lack of continuous data. The lack of continuous data can be caused by a line-of-sight interruption as a result of an eclipse conditions, i.e., a result of a planet, Sun, or moon blocking the data transmission. Another cause of lack of continuous data is the viewing geometry with respect to the Earth receiver and the deep space transmitting source due to the rotation of the Earth.

A further problem with prior art deep space communications systems is the inability to transmit data from the deep regions of space to a centralized Earth receiving station regardless of the Earth's location about the Sun. This problem may be caused by an eclipse situation with respect to the Earth receiver station and the combined effect of Earth rotation.

Accordingly, it is desirable to decrease the antenna size onboard the mission satellite and provide a high bandwidth communication system for communicating between deep space and Earth. It is also desirable to have a deep space communications network that overcomes the above described problems with the prior art by providing a continuous communications network permitting reliable high bandwidth communications between a deep space mission and a user.

### SUMMARY OF THE INVENTION

The present invention employs at least one satellite (“planetoid”) in an Earth-like orbit about the Sun. The present invention enables high availability, continuous wide band line-of-sight communications between deep space missions and one or more planetoid satellites that can be placed in an orbit about the Sun. The present invention affords significant performance advantages over prior art for deep space communications.

According to one aspect of the present invention, the present invention permits the direct transfer of data between a deep space mission (referred to as the “mission”) and a planetoid. A planetoid is herein described as a satellite placed in an orbit about the Sun. In one embodiment, the planetoid is placed in the Earth's orbit about the Sun. In another embodiment, the planetoid is placed in a plane tilted at an angle from the Earth's ecliptic plane. A method of deep space communication between a deep space location and Earth includes communicating between the planetoid and the deep space location via an optical communications link and communicating between Earth and the planetoid by either an optical or an RF link.

The planetoid includes a communications payload to facilitate the deep space communications. The payload can include an optical transceiver, a RF transmitter, a laser, a telescope, an optical to RF converter, and pointing and control circuitry for the telescope and laser. The planetoid can facilitate a communications link between the mission and the user. The user can be any user including a user on Earth, an airborne or endo-atmospheric user, an exo-atmospheric user, an Earth orbiting satellite, an Earth GEO-stationary or Earth GEO synchronous spacecraft, a high altitude endo/exo-atmospheric platform including an Aerostat, a terrestrial land based, sea based or submersible based fixed or mobile transmitters/receivers, or heavenly bodies or artifact. The mission can be any deep space mission. A planetoid system orbiting the Sun includes a satellite health module for maintaining the planetoid in an orbit, a payload adapted to communicate between a location in deep space and an Earth user, and an interface mechanically and electronically connecting the payload and the satellite health module.

In another aspect of the present invention, the present invention can use a hybrid RF and optical approach to the communications network. In that embodiment, an optical communications link is established between the deep space mission and the planetoid. There are several advantages to using an optical link that overcomes the above described problems with the prior art communications systems such as reduced antenna size and weight and avoiding line-of-sight problems. The planetoid can receive the optical signal and convert it to an RF signal for transmission to the user. In this embodiment, the communications network would work in a similar fashion for communication between the user and the deep space mission, the user can use an RF link to communicate with the planetoid, the planetoid can convert the signal to an optical signal, and transmit it to the deep space mission.

### BRIEF DESCRIPTION OF THE DRAWINGS

FIG. 1 is an illustration of one embodiment of a deep space communications system in accordance with the present invention;

FIG. 2 is an illustration of another embodiment of a deep space communications system in accordance with the present invention;

FIG. 3 is an illustration of another embodiment of a deep space communications system in accordance with the present invention;

FIG. 4 is an illustration of one embodiment of a planetoid in accordance with the present invention;

FIG. 5 is an illustration of one embodiment of a planetoid payload in accordance with the present invention; and

FIG. 6 is a flow chart showing the flow of communication in accordance with one embodiment of the present invention.

### DETAILED DESCRIPTION OF THE PREFERRED EMBODIMENT

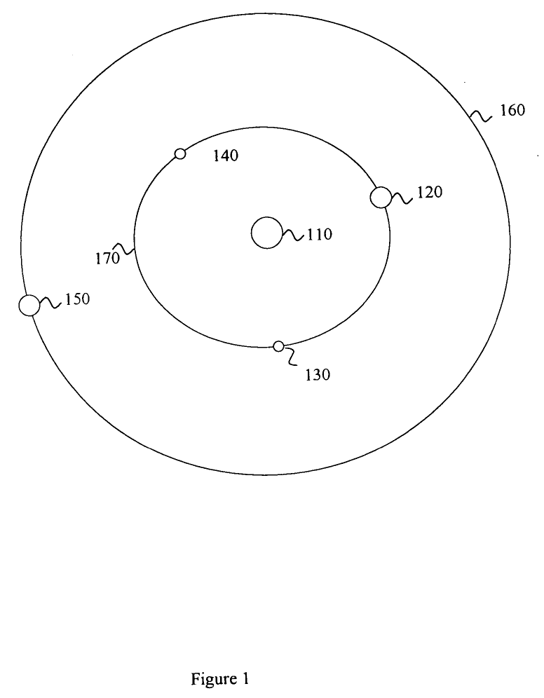

FIG. 1 shows a deep space communications network including a planet, moon, etc., such as Jupiter 150 (one place where a deep space mission could be directed and therefore referred to interchangeably as a “mission”), two planetoids 130 and 140, Earth 120 (one place where a user could be placed and therefore referred to interchangeably as a “user”), the Sun 110, and two orbits 160 and 170. Deep space is typically considered to be all space beyond an Earth GEO-synchronous or GEO-stationary orbit.

The present invention permits high bandwidth, continuous, and efficient communication between a user and a deep space mission and is intended to provide a communications network for establishing a communications link between any deep space mission and any user. A deep space mission to Jupiter and a user on Earth will be described as one embodiment of the present invention. It will be understood to one of ordinary skill in the art that although the present invention describes a deep space mission location to be Jupiter 150, the present invention is not limited to Jupiter and may apply to communications between any deep space location and any user.

As described above, one likely deep space mission is a mission to Jupiter 150. FIG. 1 shows a deep space mission in which it is desirable to transmit data from Jupiter 150 to the Earth 120 on a continuous basis over a range from approximately 1 to approximately 7 Astronomical Units (AU) or greater. (One AU is approximately equal to 93 million miles, the mean distance between the Earth 120 and the Sun 110.) The Sun 110 is shown to lie in a direct line-of-sight between Jupiter 150 and Earth 120 inhibiting communications between both points due to obstruction by the Sun 110. The present invention overcomes this line-of-sight problem by using artificial planetoids 130 and 140 that can be inserted into an Earth-like orbit.

One embodiment of the present invention uses a hybrid approach to the communications network. A communications link between the deep space mission 150 and the planetoid 130 or 140 can be established using an optical communications link. The optical beam can be sufficiently sized so as not to complicate beam steering and stabilization by the signal source host at the mission 150. Since, in this embodiment, there are at least two planetoids 130 and 140, the deep space mission can communicate continuously with at least one of the planetoids 130 and 140 without a line-of-sight problem. In other words, there is no eclipse or no time when either the Sun 110, Earth 120, or another planet or moon (not shown) is blocking the communications path between the deep space mission and at least one of the planetoids 130 and 140. A single planetoid 130 or 140 can be used or a plurality of planetoids 130 and 140 can be used. In one embodiment where a plurality of planetoids 130 and 140 is used, the planetoids 130 and 140 are approximately equally spaced from each other in their orbit.

It may also be desirable to convert optical data received from the mission source at Jupiter 150 by planetoid 130 or 140 to an RF medium between the planetoid 130 or 140 and at least one Earth 120 receiving station. Such a concept of operations may be applicable between the planetoid 130 or 140 and Earth 120 in the absence of a cloud-free line-of-sight(s) which otherwise could preclude link closure between both points. In one embodiment the K-band is used in the RF medium. The K-band is a high frequency communications band. RF communications can also use Bandwidth Efficient Modulation (BEM) techniques employed to reduce planetoid relay antenna size, to increase bandwidth with improved forward error encoding of the transmission for a lower bit error rate, and to further reduce transmitter power Effective Isotropic Radiated Power (EIRP).

The communication between the planetoid 130 or 140 and Earth 120 can also be accomplished using an optical link or the planetoid 130 or 140 can determine or can be commanded to select whether to use an optical link or an RF link between the planetoid 130 or 140 and Earth 120 depending upon atmospheric conditions.

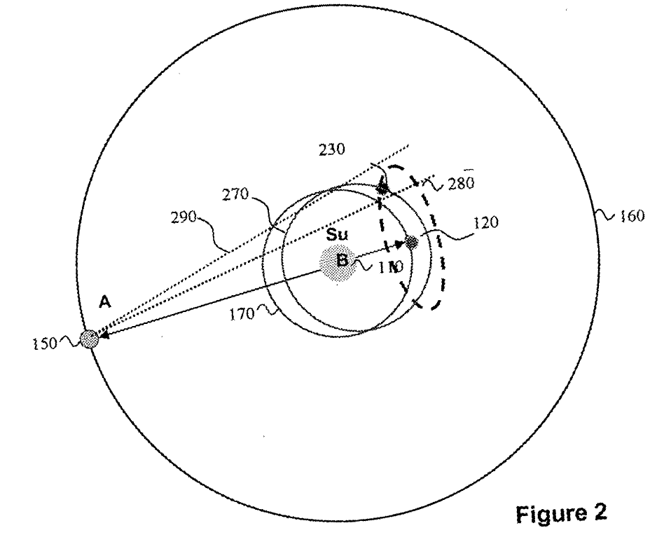

In the embodiment shown in FIG. 1, the planetoids 130 and 140 are orbiting the Sun 110 in substantially the same orbit 170 as Earth 120. Thus, orbit of planetoid 130 and 140 has the same period as the orbit of Earth, i.e., orbit 170. In the example shown in FIG. 2, the planetoids 130 and 140 are inserted into an Earth-like orbit inclined with respect to the Earth's ecliptic plane about the Sun 110. As shown in FIG. 2, if one or a plurality of artificial planetoids (satellites) 130 and 140 is inserted into an Earth-like orbit but inclined with respect to the Earth's ecliptic plane about the Sun 110, direct viewing between Jupiter 150 and planetoid 130 or 140 is achievable permitting the continuous transfer of data between both points without concern for conditions of short term eclipse. Although a single planetoid 130 ensures direct line-of-sight viewing between Jupiter 150 and a planetoid 130 or 140, a plurality of planetoids 130 and 140 ensures backup redundancy and can also provide for the accommodation of multiple missions and reduce cost and complexity associated with use of an otherwise single planetoid 130 or 140.

FIG. 2 shows an embodiment of the present invention where a planetoid 230 is inserted into an Earth-like orbit that is tilted approximately 300 from the plane of the Earth's ecliptic orbit. As shown in FIG. 2, there exists Sun 110, Jupiter 150, Earth orbit 170, planetoid 230, planetoid orbit 270, apparent planetoid orbit 280 with respect to the Earth 120, Jupiter orbit 160, and dashed lines 290 indicate diffraction limited optical beam sized to a preferred beam width with respect to an Earth-based receiver or other receiver located on a heavenly body or an artifact. Similarly to FIG. 1, Earth 120 is shown in eclipse with respect to Jupiter 150.

In FIG. 2, at least one planetoid 230, can be placed in an Earth-like orbit 270 inclined with respect to the Earth ecliptic to a desired angle so as to avoid eclipse by the Sun 110 with respect to the orientation of the mission 150 and Earth 120. This communication system can be achieved with the use of only a single planetoid 230. However, two or more planetoids 230 can be used for user redundancy or for multiple mission communication.

When the planetoid 230 orbit plane is tilted off of Earth's ecliptic plane 170, an apparent orbit with respect to the Earth is formed 280. The apparent orbit 280 with respect to the Earth 120 can be thought of as a fixed closed path which resides in a rotating frame where the Earth 120 is also approximately fixed. The rotating non-inertial coordinate frame rotates about an axis normal to the Earth's orbit plane with the Sun 110 at center and at a mean rate equal to the Earth's rotation about the Sun.

In another embodiment, a plurality of planetoids 230 in multiple planes can be deployed consistent with the practice of this invention by placing them in orbits about the Sun 110 such that they follow the same apparent orbit path about the Earth 280 or in nominally concentric paths. If they are equally spaced in a mean sense along a common path each will be in separate planes equally spaced in ascending nodes around the ecliptic plane at a common inclination angle, eccentricity, and argument of perigee of either 270° or 90° from the node. The selection of argument of perigee defines the direction of rotation about the Earth. The relative phasing with respect to these nodes in terms of mean anomaly can be as defined by the conventional Walker code of N/N/N-1. The combination of eccentricity and inclination for near circular apparent Earth orbits can be approximated by the relationship (I=2e) expressed in radians. Nominally concentric orbits result when the inclinations and eccentricities of orbits are not identical.

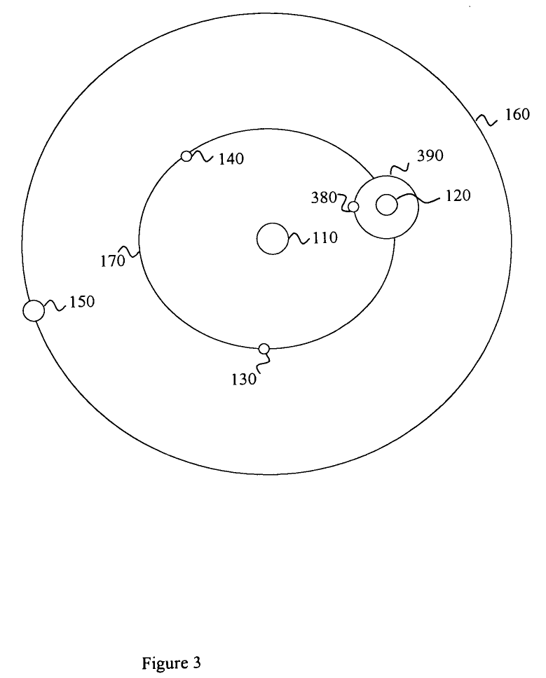

FIG. 3 shows yet another embodiment of the present invention which includes Sun 110, Earth 120, planetoids 130 and 140, Jupiter 150 mission, Jupiter orbit 160, Earth orbit 170, satellite 380 and satellite orbit 390. In this Figure, two planetoids 130 and 140 are shown, however, any number of planetoids (one or more) can be used. This embodiment can use the hybrid communication approach described with respect to FIG. 1 or any other communications approach for communication between mission 150 and user 120. The communication between the mission 150 and the planetoid 130 or 140 can be established (using an optically modulated signal). Communication between the planetoid 130 or 140 and the user 120 can occur directly (using an optically modulated signal or an RF modulated signal) or it can occur using satellite 380 as a relay. Communication between the mission 150 and satellite 380 can occur directly when it is advantageous to do so. Satellite 380 can be equipped with communications equipment similar to the communications equipment onboard planetoid 130 and 140 to support communications with mission 150. Satellite 380 is a satellite in Earth orbit 390. Satellite 380 can be one or more satellites in orbit about the Earth 120. One convenient Earth orbit for satellite 380 can be a GEO orbit, however, any Earth orbit can be implemented for satellite 380.

This embodiment can ensure total Earth 120 global connectivity to mission 150 at any given time. Other variations of this embodiment include, data transfer via planetoid 130 or 140 relayed to at least one Earth satellite 380, to a compatible communications backbone, or to one or a plurality of exo-atmospheric or endo-atmospheric receivers including Aerostats for subsequent relay to, and use by a user. This embodiment is particularly applicable when there are a limited number of Earth 120 receiving stations in preferred geographical locations and to account for Earth rotation which may restrict the viewing geometry between planetoid 130 or 140 and the desired Earth receiving station. If there are multiple Earth receiving stations around the planet, planetoid 130 or 140 can exchange data with a user 120 without regards to Earth rotation.

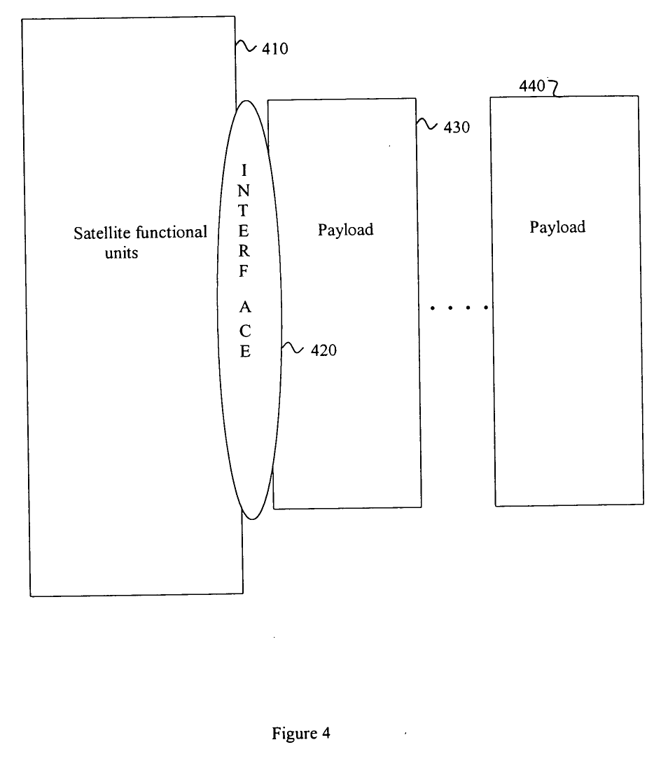

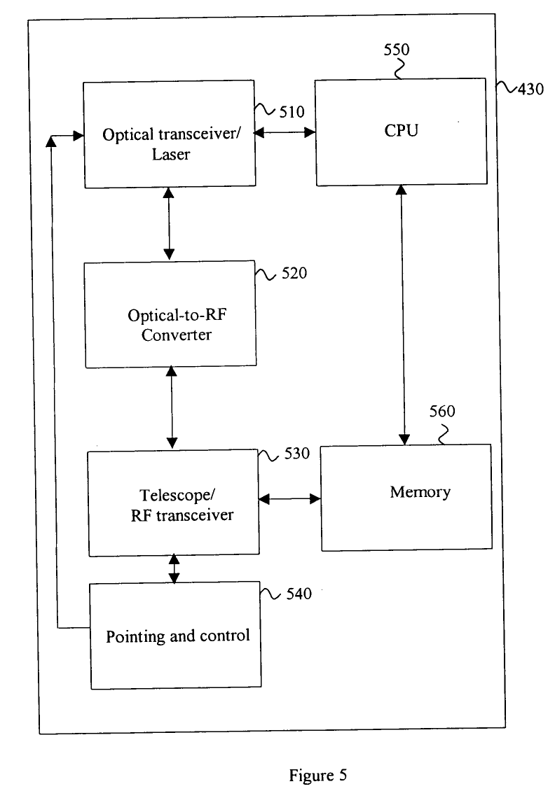

FIG. 4 shows one embodiment of a planetoid 130, 140, 230, or 380 including satellite functional units 410, an interface 420, and at least one payload 430 or 440. The satellite functional units 410 are similar to any Earth orbiting satellite. The payload 430 or 440 includes all the planetoid specific functionality and will be described in detail with respect to FIG. 5. The interface 420 provides a mechanical and electrical interface between any generic satellite and a functional planetoid payload 430. In one embodiment, the satellite functional units 410 include no more than the subsystems that maintain the health and orbit of the planetoid and all planetoid unique subsystems are included in the payload 430. In one embodiment, the payload is expandable by adding at least one additional payload 440. The payload can be added either prior to launch or remotely after launch.

The satellite functional units 410 include an attitude control subsystem for maintaining attitude control of the planetoid, a power subsystem for maintaining power to the planetoid, a telemetry, tracking, and commanding subsystem for transmitting planetoid telemetry, receiving planetoid commands, and enabling tracking of the planetoid, and a thermal subsystem for maintaining a desired temperature on the planetoid. These subsystems are common on most satellites.

FIG. 5 shows one embodiment of the planetoid payload 430 including an optical receiver and demodulator 500, an optical modulator and transmit telescope 510, a RF modulator and transceiver 520, a pointing and control subsystem 530, a central processing unit (CPU) 540 and a storage device 550 which may be volatile or non-volatile in form. CPU 540 can accomplish any necessary processing for running any software programs on the payload 430. Storage device 550 operates in conjunction with CPU 540 and can function to store demodulated optical receiver 500 data from mission 150 or user 120. The pointing and control 530 can function to provide positioning control of the RF modulator and transceiver 520, the optical modulator and transmit telescope 510, and optical receiver and demodulator 500 apertures. The planetoid payload 430 can operate as a relay functioning to relay an optical signal from mission 150 to the user 120 or vice-versa. The planetoid payload 430 can also operate as a converter to convert between optical and RF signals and retransmit the signal in the desired format.

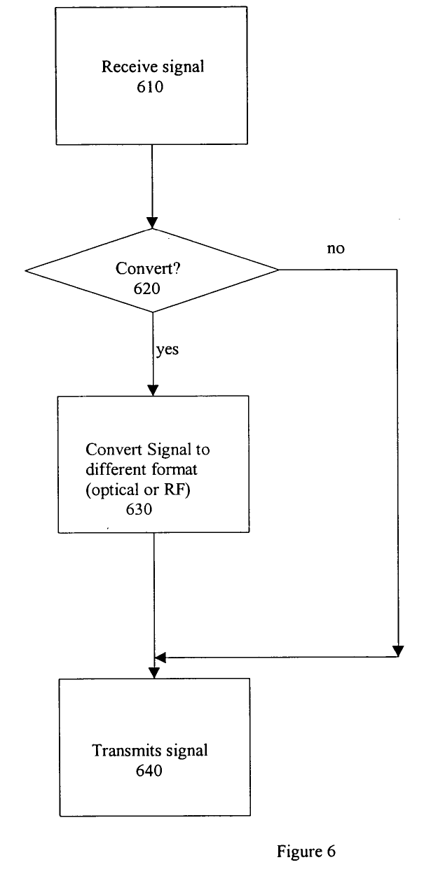

Communications between the mission 150 and the user 120 can operate in the following manner as shown in FIG. 6. The user can transmit data using an RF medium to the planetoid 430. Referring to FIG. 6, in step S610, the planetoid 430 receives the optical data using optical receiver and demodulator 500. If the optical signal is to be converted to an RF signal as shown in decision element S620, user 120 can select whether to transmit optical data or RF data by step 630. If optical data is not converted, flow proceeds to step S640 where the optical data is transmitted using optical modulator and transmit telescope 510. If optical data is converted, flow proceeds to step S630 where converted data can be transmitted using RF modulator and transceiver 520. Pointing and control subsystem 530 can be used to establish and control pointing of the selected aperture(s) and may provide simultaneous control of optical receiver and demodulator aperture 500 and either (or both) RF modulator and transceiver 520 and optical modulator and transmit telescope 510 apertures.

Communications between the user 120 and mission 150 can operate in a similar fashion to the above described communications. The user 120 can transmit data using an RF medium to the planetoid 430. Referring to FIG. 6, in step S610, the RF data signal can be received by the planetoid 430 using the RF modulator and transceiver 520 which is capable of establishing RF link closure to the user 120. In one embodiment, data received can be stored in storage device 550 for subsequent transmission or converted by CPU 540 based on user 120 control decision shown in step S620 if it is desired to convert the RF signal to an optical format. RF data is converted into an optical format by optical modulator and transmit telescope 510 as shown in step S640. If the RF data signal is not converted into an optical format or stored in storage device 550 for subsequent RF transmission, RF modulator and transceiver 520 can transmit the data signal.

There can be one, or more than one of any of the subsystems within the payload to accommodate one or multiple optical channels received by optical receiver and demodulator 500. For example, it may be advantageous to have a plurality of optical receivers and demodulators 500 to support a plurality of missions 150. Each planetoid optical receiver and demodulator 500 could then be capable of independent channel modulation and independently steerable by a dedicated pointing and control system 530 to support multiple mission 150 requirements.

In another embodiment, the payload 430 does not convert data from optical to RF signals or from RF to optical signals S620. Instead the planetoid 430 acts as a relay and receives and retransmits the data in the same format to an Earth-orbiting satellite 380.

From the above description, it will be apparent that the invention disclosed herein provides a novel and advantageous system and method of deep space communications.

While the present invention has been discussed with respect to what is presently considered to be the preferred embodiment, it is to be understood that the invention is not limited to the disclosed embodiment. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A method of deep space communication between a deep space location and Earth, comprising:
communicating between a planetoid and the deep space location via an optical communications link; and
communicating between a user and the planetoid.

2. The method of claim 1, wherein the communicating between the user and the planetoid further comprises communicating between the user and a satellite in an orbit about the Earth and communicating between the satellite and the planetoid.

3. The method of claim 1, wherein communicating between the user and the planetoid further comprises communicating using a radio frequency communications link.

4. The method of claim 1, wherein communicating between the user and the planetoid further comprises communicating using an optical communications link.

5. The method of claim 1, further comprising employing a satellite in an orbit about the Earth adapted to receive communications from the planetoid and adapted to transmit communications to a user on Earth.

6. The method of claim 1, wherein placing a planetoid in an orbit about the Sun further comprises placing a plurality of planetoids in an orbit about the Sun.

7. The method of claim 6, wherein the plurality of planetoids are geometrically substantially evenly distributed in the orbit about the Sun.

8. The method of claim 1, wherein the placing the planetoid in the orbit about the Sun further comprises placing the planetoid in a substantially similar orbit to the Earth's orbit about the Sun.

9. The method of claim 8, wherein a plane of the orbit substantially similar to Earth's orbit is tilted with respect to a plane of the Earth's orbit about the Sun.

10. A planetoid system orbiting the Sun comprising:
a satellite health module for maintaining a planetoid in an orbit;
a payload adapted to communicate between a location in deep space and an Earth user; and
an interface mechanically and electronically connecting the payload and the satellite health module.

11. The planetoid system of claim 10, wherein the satellite health module further comprises:
an attitude control subsystem for maintaining attitude control of the planetoid;
a power subsystem for maintaining power to the planetoid including powering the attitude control subsystem and the payload;
a telemetry, tracking, and commanding subsystem for transmitting planetoid telemetry, receiving planetoid commands, and enabling tracking of the planetoid; and
a thermal subsystem for maintaining a desired temperature on the planetoid.

12. The planetoid system of claim 10, wherein the payload further comprises:
an optical transceiver for transmitting and receiving optical signals;
a radio frequency transmitter for transmitting radio frequency signals; and
an optical to radio frequency converter for converting a signal from optical to radio frequency and from radio frequency to optical.

13. The planetoid system of claim 12, wherein the payload further comprises a memory and a central processing unit.

14. The planetoid system of claim 12, wherein the payload further comprises a telescope.

15. A method of deep space communication using at least one planetoid to communicate between a deep space location and a user, the method comprising:
receiving a communication signal in a first data format;
converting the communication signal into a second data format; and
transmitting the communication signal in the second data format.

16. The method of claim 15, wherein the first data format is an optical format.

17. The method of claim 15, wherein the first data format is a radio frequency data format.

18. The method of claim 15, wherein the second data format is an optical data format.

19. The method of claim 15, wherein the second data format is a radio frequency data format.

20. The method of claim 15, further comprises storing the communication signal in the first data format in a memory on the planetoid.

21. The method of claim 15, further comprises storing the communication signal in the second data format in a memory on the planetoid.

22. The method of claim 15, further comprising processing the communication signal on the planetoid.
